(19) United States
(12) Patent Application Publication
(10) Pub. No.: US 2017/0105239 A1
(43) Pub. Date: Apr. 13, 2017

(54) METHODS AND APPARATUS FOR A NETWORK-AGNOSTIC WIRELESS ROUTER

(71) Applicant: Behzad Mohebbi, San Diego, CA (US)

(72) Inventor: Behzad Mohebbi, San Diego, CA (US)

(21) Appl. No.: 15/334,221

(22) Filed: Oct. 25, 2016

Related U.S. Application Data
(62) Division of application No. 14/156,174, filed on Jan. 15, 2014.
(60) Provisional application No. 61/849,087, filed on Jan. 18, 2013.
(60) Provisional application No. 61/848,950, filed on Jan. 16, 2013.

(51) Int. Cl. H04W 76/02; H04W 12/06; H04L 29/06

(52) U.S. Cl. CPC H04W 76/022; H04L 63/0892; H04W 12/06; H04W 92/02

(57) ABSTRACT

Apparatus and methods for a network-agnostic wireless router. In one embodiment, the network-agnostic wireless router is configured to provide an access tunnel (e.g., a so-called “Wi-Fi PIPE') via a first network (e.g., a Wi-Fi network), and convert the data payload for transfer over a second network (e.g., a LTE network). Since the wireless router provides an access tunnel and does not behave as a logical endpoint, the authentication, authorization, and accounting mechanisms are handled directly between the subscriber's identity module (e.g., SIM, USIM, CSIM, RUIM, etc.) and the network operator's authentication process (e.g., Authentication Center or AuC). The disclosed wireless router is free to support multiple different networks to provide access that is “agnostic” to the underlying subscriber device's network preferences.

### PRIORITY AND RELATED APPLICATIONS

This application claims priority to co-pending U.S. patent application Ser. No. 14/156,174, filed on Jan. 15, 2014 and entitled “Methods And Apparatus For A Network-Agnostic Wireless Router,” which claims priority to co-owned U.S. Provisional Patent Application Ser. Nos. 61/849,087 filed on Jan. 18, 2013 and entitled “Network-agnostic Wireless Router (NAWR)”, and 61/848,950 filed on Jan. 16, 2013 and entitled “Wi-Fi Over LTE Network (WoLTEN)”, the foregoing each being incorporated herein by reference in its entirety. This application is related to commonly owned and co-pending U.S. patent application Ser. No.: 14/156,339, entitled “METHODS AND APPARATUS FOR HYBRID ACCESS TO A CORE NETWORK”, filed on Jan. 15, 2014, incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technological Field

The present disclosure relates generally to the field of wireless communication and data networks. More particularly, in one exemplary aspect, the disclosure is directed to methods and apparatus for a network-agnostic wireless router.

2. Description of Related Technology

The rapid growth of mobile data services accelerated by the advent of so-called “smartphone” technologies has resulted in a steep increase in the volume of high-speed data transmission and the popularity of mobile services. Coupled with the increased popularity is an increased customer expectation for better and more reliable services and network capabilities. Operators have deployed new access technologies such as Long Term Evolution (LTE) to meet the customer demands. Even so, operators are still searching for viable solutions to improve network reliability and Probability-Of-Coverage (POC), especially in indoor environments. Operators traditionally have used repeaters and Distributed Antenna Systems (DAS) for providing indoor coverage. However, repeaters and DAS solutions are losing commercial momentum as they cannot support a variety of desirable features such as Multiple Input Multiple Output (MIMO) and high-order modulation.

Recently, the Third Generation Partnership Project (3GPP) community, encouraged by operators, began considering and developing standards for a new class of products known as “Relays” (see e.g., 3GPP TR 36.806 V9.0.0 entitled “3rd Generation Partnership Project; Technical Specification Group Radio Access Network; Evolved Universal Terrestrial Radio Access (E-UTRA); Relay architectures for E-UTRA (LTE-Advanced) (Release 9)”, published March of 2010, and incorporated herein by reference in its entirety). Unfortunately, relay performance may be limited by available spectrum, since relays generally require twice as much spectrum to relay and maintain maximum throughput of a given LTE enhanced Node B (eNB) base station.

In alternative proposals, so called “wireless routers” can be used to provide a Wi-Fi™ “hotspot”. The wireless router uses a wireless cellular connectivity (e.g., LTE, High Speed Packet Access (HSPA), etc.) instead of a wired backhaul (e.g., Digital Subscriber Line (DSL), cable modem, etc.). Fourth Generation (4G) wireless routers can offer considerable advantages when compared to relays; in particular, Wi-Fi hotspots operate in unlicensed (license exempt) bands where there is an abundance of spectrum (the Industrial Scientific and Medical (ISM) and Unlicensed National Information Infrastructure (UNIT) bands may provide nearly 0.5 GHz of spectrum).

While wireless routers have certain advantages over relays, one significant issue with wireless router operation is that the cellular service is terminated at the wireless router, and not at the subscriber's user equipment (UE) (e.g., handset, or other wireless communications device). More directly, the network treats the wireless router as the endpoint. As described in greater detail hereinafter, this manner of operation introduces new problems with e.g., security, billing, etc. Additionally, Wi-Fi hotspot Medium Access Control (MAC) and Physical (PHY) layers are designed to operate in an “ad hoc” uncoordinated network, where, unlike cellular systems, interfering sources and their operation are not coordinated or planned.

In view of these deficiencies, improved methods and apparatus are needed for wireless routers. Such improvements would ideally provide one or more of network-agnostic operation, end-to-end network and radio security, flexibility to use different frequency bands (licensed and/or unlicensed), and consistent service capabilities e.g., Quality of Service (QoS), etc.

### SUMMARY

The present disclosure satisfies the aforementioned needs by providing, inter alia, improved apparatus and methods for network-agnostic wireless router services.

In a first aspect of the disclosure, a method for network-agnostic wireless routing is disclosed. In one embodiment, the method includes: receiving one or more connection requests from corresponding one or more subscriber devices via a wireless local area network (WLAN), the one or more connection requests identifying a corresponding one or more cellular networks; allocating a storage space to a subscriber device corresponding to the connection request; tuning to a cellular network identified within the connection request; and transacting data received via the tuned cellular network with the subscriber device via an access tunnel.

In one variant, the method includes determining that each connection request can be serviced; and based at least on the determination, performing the acts of allocating, tuning, and transacting.

In another variant, the determination includes determining that storage space can be allocated. In one example, the determination includes successfully tuning to the identified corresponding one or more cellular networks. In another such example, the determination includes determining whether a limited set of cellular network radio components has at least one cellular network radio component available for use.

In yet another variant, the WLAN is configured to operate in a substantially open mode, the open mode not requiring any access control measures. Alternatively, the WLAN is configured to operate in a substantially closed mode, the closed mode configured to implement at least one access control function.

In one exemplary implementation, the one or more cellular network includes a Long Term Evolution (LTE) network configured to perform access control based on an Authentication Key Agreement (AKA) procedure with a Subscriber Identity Module (SIM) indigenous to the subscriber device via the WLAN provided by a network agnostic router.

In a second aspect of the disclosure, a wireless router apparatus configured to agnostically provide network connectivity is disclosed. In one embodiment, the wireless router apparatus includes: one or more first radio interfaces, the one or more first interfaces configured to connect to one or more wireless data networks, where each one of the one or more wireless data networks are configured to limit access to a corresponding group of subscriber devices; a second radio interface, the second interface configured to provide an open wireless network; a processor; and a non-transitory computer readable medium in data communication with the processor. In one such embodiment, the non-transitory computer readable medium includes one or more instructions which when executed by the processor, causes the network-agnostic wireless apparatus to: responsive to receiving a connection request for a wireless data network from a subscriber device connected to the open wireless network: provide an access tunnel between the subscriber device and the wireless data network, the access tunnel configured to enable the exchange of encrypted data payloads without modification.

In one variant, the wireless router apparatus of further includes a buffer configured to support multiple data pipe instances.

In a second variant, the second interface is configured to provide access to a Wireless Local Area Network (WLAN), and the one or more first radio interfaces are configured to connect to one or more Long Term Evolution (LTE) cellular data networks.

In another variant, the encrypted data payload includes access control information configured to identify the subscriber device as one of the group of subscriber devices corresponding to the wireless data network.

In still other variants, at least two of the one or more first radio interfaces are each configured for use with different radio technologies.

In a third aspect of the disclosure, a method for connecting to a first data network via a network-agnostic wireless router is disclosed. In one embodiment, the method includes: discovering a network-agnostic wireless router configured to provide network connectivity agnostically; transmitting a connection request; the connection request identifying a first data network; and responsive to receiving a connection grant, initiating at least one access control procedure with the first data network via an access tunnel identified by the connection grant. The at least one access control procedure includes transmitting an encrypted data payload that is configured for secure authentication with the first data network.

In one variant, the wireless network includes an open Wireless Local Area Network (WLAN) and the first data network includes a Long Term Evolution (LTE) cellular data network. In one example, the access control procedure includes an Authentication and Key Agreement (AKA) between a Subscriber Identity Module (SIM) of the subscriber device and the Authentication Center (AuC) of the LTE cellular data network. In another example, the access tunnel is configured to receive the encrypted data payload via the WLAN and provide the encrypted data payload to a software layer of a LTE software stack. In one such case, the software layer includes a Radio Link Control (RLC) layer of the LTE software stack.

In another variant, the connection grant includes a buffer identifier that is uniquely associated with the access tunnel.

In a fourth aspect of the disclosure, a subscriber device configured to connect to a first network via a network-agnostic wireless router is disclosed. In one embodiment, the subscriber device includes: a radio interface, the radio interface configured to connect to a network-agnostic wireless router, where the network-agnostic wireless router configured to connect to the first network; a processor; and a non-transitory computer readable apparatus including one or more instructions. In one embodiment, the one or more instructions, when executed by the processor, cause the subscriber device to: transmit a connection request for the first network to the network-agnostic wireless router; and responsive to receipt of a connection grant, transact one or more encrypted data payloads via an access tunnel.

In one variant, the one or more encrypted data payloads includes a cryptographic challenge and response test configured to establish secure communications with the first network.

In a fifth aspect of the disclosure, a method for wireless communications including first and second communications systems, where the first communications system has at least a first node and a second node in communications with each other is described. In one embodiment, the method includes: modifying a protocol stack of the first node, said modification including splitting the protocol stack into a first portion of layers and a second portion of layers, the first portion of layers and the second portion of layers configured to transact one or more data payloads; executing the first portion of layers within the first node, and causing a third intermediary node to execute the second portion of layers; communicating the one or more data payloads via the second communications system. In another embodiment, the connecting second access network does not modify the one or more data payloads. In a third embodiment, the combined execution of the first portion of layers and the second portion of the layers enables communications with the second node in the first communications system via the third intermediary node.

In one variant, the first node includes a handset and the second node includes a base station of a cellular network, and the second communications system is a Wireless Local Area Network (WLAN). In another variant, the handset includes a user equipment (UE), the base station includes a Long Term Evolution (LTE) enhanced NodeB (eNB), the cellular network includes an LTE 4G system, and the WLAN includes a Wi-Fi network. In a further variant, the splitting occurs between a radio link control (RLC) layer and medium access control (MAC) layer of a LTE protocol stack.

In yet another variant, the communications system provides an access tunnel between the first portion of layers and the second portion of layers in an unsecure open mode. Alternatively, the second communications system provides an access tunnel between the first portion of layers and the second portion of layers in a secure closed mode.

In one exemplary implementation, a key configured to encrypt data transactions with the third intermediary node or a credential configured to authenticate the third intermediary node of the second communications system is provided to the first node and the third intermediary node via the second node in the first communications system.

In another implementation, the third intermediary node is a Network Agnostic Wireless Router (NAWR). In one implementation, the first node is configured to execute a NAWR software application, and/or the third node is configured to execute a Network NAWR agent application. In one such case, a NAWR dedicated control channel exists between the NAWR software application and the NAWR agent. In one such implementation, the NAWR software application includes a multiplexing and de-multiplexing (MUX/DeMUX) buffer; in other implementations, the NAWR agent application includes a multiplexing and de-multiplexing (MUX/DeMUX) buffer.

In some variants, the NAWR is further configured to communicate with one or more handsets. In other variants, the NAWR is further configured to communicate with one or more base stations simultaneously, at least a portion of the base stations having different Public Land Mobile Networks (PLMNs).

A method for wireless communications via a first and a second communications systems where the first communications system has at least a first node and a second node in communications with each other is disclosed. In one embodiment, the method includes: modifying a protocol stack of the first node, said modification including splitting the protocol stack into a first portion of layers and a second portion of layers, the first portion of layers and the second portion of layers configured to transact one or more data payloads; executing the first portion of layers within the first node, and causing a third intermediary node to execute a second portion of layers; communicating the one or more data payloads via the second communications system, where the second communications system does not modify the one or more data payloads; and where the combined execution of the first portion of layers and the second portion of the layers enables communications with the second node in the first communications system via the third intermediary node.

In one variant, the splitting occurs between a radio link control (RLC) layer and medium access control (MAC) layer of a Long Term Evolution (LTE) protocol stack.

In a second variant, the method further includes providing an access tunnel via the second communications system between the first portion of layers and the second portion of layers in an unsecure open mode.

In a third variant, the method further includes providing an access tunnel via the second communications system between the first portion of layers and the second portion of layers in a secure closed mode. In one such implementation, the method further includes receiving (i) a key configured to encrypt data transactions with the third intermediary node, or (ii) a credential configured to authenticate the third intermediary node of the second communications system, and the key or credential is received from the second node in the first communications system. In one such variant, the method further includes providing the key or credential to the third intermediary node, where the third intermediary node is a Network Agnostic Wireless Router (NAWR). In another such variant, the method further includes executing a NAWR software application and/or communicating with a NAWR agent application executing on the third intermediary node. In some such cases, the method further includes establishing a NAWR dedicated control channel between the NAWR software application and the NAWR agent.

A user equipment (UE) apparatus configured to communicate with a base station (BS) via an intermediary access point (AP) is disclosed. In one embodiment, the UE apparatus includes: a first wireless interface for communication with the BS; a second wireless interface for communication with the intermediary AP; a processor; and a non-transitory computer readable medium including one or more instructions. In one exemplary embodiment, when the processor executes the instructions, the UE apparatus: modifies a protocol stack including a first portion of layers and a second portion of layers configured to transact one or more data payloads, where the modification includes execution of a first portion of layers of the protocol stack without execution of a second portion of layers of the protocol stack; establishes an access tunnel to the intermediary AP via the second wireless interface; and causes the intermediary AP to execute the second portion of layers; communicates the one or more data payloads via the access tunnel, where the access tunnel does not modify the one or more data payloads; and where the combined execution of the first portion of layers and the second portion of the layers enables communications with the BS via the intermediary AP.

In one variant, the first wireless interface includes a Long Term Evolution (LTE) compliant interface and the second wireless interface includes a Wireless Local Area Network (WLAN).

In a second variant, the non-transitory computer readable medium further includes one or more instructions that when executed by the processor, causes the UE apparatus to execute a Network Agnostic Wireless Router (NAWR) software application that is configured to interface with a NAWR agent of the intermediary AP. In one such variant, the NAWR software application includes a multiplexing and de-multiplexing (MUX/DeMUX) buffer.

In a third variant, the non-transitory computer readable medium further includes one or more instructions that when executed by the processor, causes the UE apparatus to receive (i) a key configured to encrypt data transactions with the intermediary AP via the second wireless interface, or (ii) a credential configured to authenticate the intermediary AP; and the key or credential is received from the BS.

An intermediary access point (AP) apparatus configured to enable network agnostic access between a user equipment (UE) apparatus and one or more base stations (BSs) is disclosed. In one embodiment, the AP apparatus includes: a second wireless interface for communication with UE apparatus; a first wireless interface for communication with the one or more BS; a processor; and a non-transitory computer readable medium including one or more instructions. In one exemplary embodiment, when the processor executes the instructions, the intermediary AP apparatus: establishes an access tunnel to the UE apparatus via the second wireless interface; executes only a second portion of layers of a protocol stack including a first portion of layers and the second portion of layers configured to transact one or more data payloads with the one or more BS via the first wireless interface; and the one or more data payloads are received via the access tunnel, where the access tunnel does not modify the one or more data payloads.

In one variant, the non-transitory computer readable medium further includes one or more instructions that when executed by the processor, causes intermediary AP apparatus to execute a Network Agnostic Wireless Router (NAWR) agent that is configured to interface with a NAWR software application of the UE apparatus.

In a second variant, the NAWR agent includes a multiplexing and de-multiplexing (MUX/D eMUX) buffer.

In a third variant, the NAWR agent is further configured to communicate with multiple UE apparatus.

In a fourth variant, the NAWR agent is further configured to communicate with the one or more BSs simultaneously, at least a portion of the one or more BSs having different Public Land Mobile Networks (PLMNs).

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a block diagram representation of one exemplary embodiment of a network architecture including Long Term Evolution (LTE) cellular coverage operating in conjunction with Wi-Fi coverage to provide network access.

FIG. 2 is a logical block diagram of various logical software entities disposed within an exemplary embodiment of a wireless router, useful in accordance with various implementations described herein.

FIG. 3 is a logical software diagram representation of the various logical entities of a user data-plane protocol stack associated with the exemplary embodiment of the network architecture of FIG. 1.

FIG. 4 is a logical software diagram representation of the various logical entities of a control-plane protocol stack associated with the exemplary embodiment of the network architecture of FIG. 1.

FIG. 5 is a logical block diagram of one exemplary embodiment of the network-agnostic wireless router, in accordance with various principles described herein.

FIG. 6 is a logical block diagram of one exemplary embodiment of a dual-user and/or dual-band network-agnostic wireless router, in accordance with the various principles described herein.

FIG. 7 is a logical block diagram of one exemplary embodiment of a subscriber device, in accordance with various principles described herein.

FIG. 8 is a logical block diagram representing an exemplary embodiment of an IEEE 802.11n PHY (L1) and MAC (L2) protocol stack 800 useful in conjunction with various aspects of the present disclosure.

FIG. 9 is a logical representation of an exemplary embodiment of the Wi-Fi PIPE formed by the exemplary network-agnostic wireless router (e.g., as described in FIG. 5) and the exemplary subscriber device (e.g., as described in FIG. 7).

FIG. 10A is a logical software diagram representation of a prior art LTE software user-plane protocol stack.

FIG. 10B is a logical software diagram representation of a prior art LTE software control-plane protocol stack.

FIG. 11 is a logical software diagram representation of one exemplary embodiment of a hybrid Wi-Fi PIPE protocol stack operating beneath the Radio Link Control (RLC) layer, which has replaced the LTE MAC and L1 layers.

FIG. 12 is a logical software diagram representation of one embodiment of an overall protocol stack architecture (both user-plane and control-plane) for the subscriber device and the network-agnostic wireless router.

FIG. 13 is a logical flow diagram of one embodiment of a generalized process for discovery, initiation, and configuration of a mobility management session.

FIG. 14 is a logical flow diagram illustrating an exemplary embodiment of an initialization of a network-agnostic wireless router (NAWR) connection of one exemplary NAWR application (APP) executed on a subscriber device (UE-Subscriber or UE-S for short) platform.

FIG. 15 is a logical flow diagram illustrating an exemplary embodiment of an initialization of a network-agnostic wireless router (NAWR) connection of one exemplary NAWR agent executed on a network-agnostic wireless router.

### DETAILED DESCRIPTION

Reference is now made to the drawings, wherein like numerals refer to like parts throughout.

As used herein, the terms “cellular” and/or “wireless” are used to refer to any wireless signal for voice, video, data, or any type of communications, including without limitation Wi-Fi (IEEE 802.11 and all its derivatives such as “b”, “a”, “g”, “n”, “ac”, etc.), Bluetooth, 3G (e.g., 3GPP, 3GPP2, and UMTS), 4G (LTE, LTE-A, and other LTE derivatives, WiMAX), HSDPA/HSUPA, TDMA, CDMA (e.g., IS-95A, WCDMA, etc.), FHSS, DSSS, GSM, PAN/802.15, 802.20, narrowband/FDMA, OFDM, PCS/DCS, analog cellular, CDPD, satellite systems, millimeter wave or microwave systems, acoustic, and infrared (i.e., IrDA) and propriety wireless communication systems.

Furthermore, as used herein, the term “network” refers generally to any type of circuit-switch or packet-switched telecommunications network or other network including, without limitation, data networks (including Wi-Fi, MANs, PANs, WANs, LANs, WLANs, micronets, piconets, internets, and intranets), satellite networks, cellular networks, and telco networks.

### Overview

In one exemplary aspect of the disclosure, a network-agnostic wireless router is disclosed. The network-agnostic wireless router is, in one embodiment, configured to provide an access tunnel (e.g., a so-called “Wi-Fi PIPE') via a first network (e.g., a Wi-Fi network), and convert the data payload for transfer over a second network (e.g., an LTE network). In one implementation, the network-agnostic wireless router provides an access tunnel or pipe that enables the subscriber to use his own identification module to connect to the appropriate network. As described in greater detail elsewhere herein, the data or other payload (e.g., packets, etc.) are tunneled via Wi-Fi hotspot access and reproduced on the appropriate cellular air interface. Since the wireless router is only providing an access tunnel (and does not behave as an endpoint), the authentication, authorization, and accounting mechanisms are all handled directly between the subscriber's identity module (e.g., SIM, USIM, CSIM, RUIM, etc.), and not the router's identity module. In fact, a wireless router so enabled by the present disclosure, may not require its own identity module (other than to support legacy modes, etc., if present).

The disclosed wireless router is advantageously free to support multiple different networks, so as to provide access that is “agnostic” to the underlying subscriber device's network preferences. In some cases, the network-agnostic wireless router can tunnel access to multiple technologies (e.g., an LTE network and a CDMA network) at the same time, thereby allowing multiple subscribers of different networks to use the same hotspot. Since the network-agnostic router is merely tunneling the subscriber's device transactions through Wi-Fi access, the subscriber device maintains control-plane access. Such control-plane access enables, inter alia, the subscriber device to properly manage service requirements, such as Quality of Service (QoS), etc.

Various other advantages of the disclosed embodiments are described in greater detail hereinafter.

### Detailed Description of Exemplary Embodiments

Exemplary embodiments of the present disclosure are now described in detail. While these embodiments are primarily discussed in the context of a fourth generation Long Term Evolution (4G LTE) wireless network in combination with Wi-Fi hotspot (e.g., IEEE 802.11 n) operation, it will be recognized by those of ordinary skill that the present disclosure is not so limited. In fact, the various aspects of the disclosure are useful in any wireless network that can benefit from the network-agnostic wireless routing described herein.

### Exemplary Network Architecture—

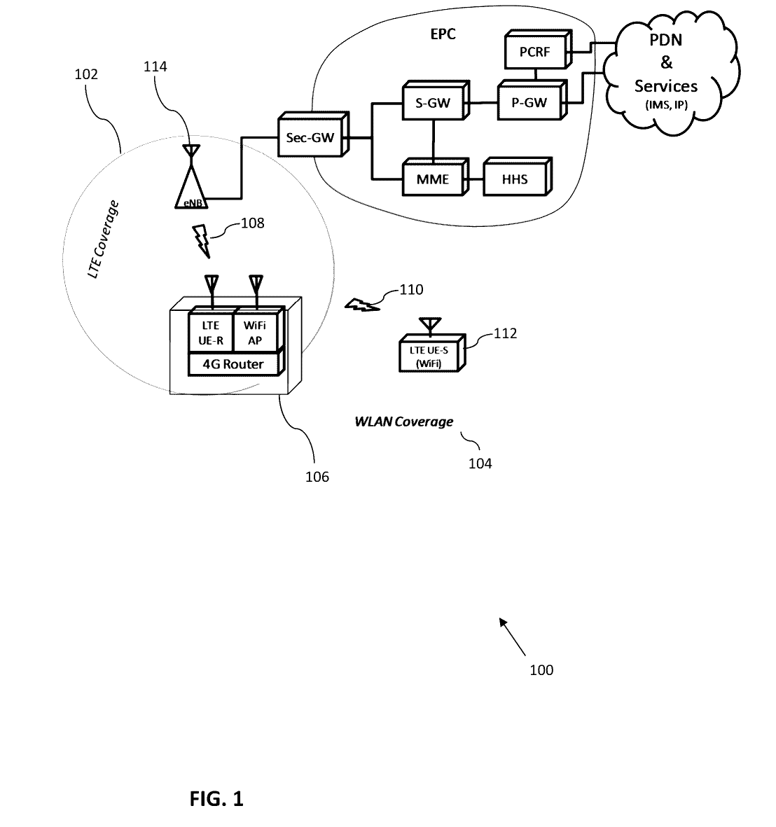

Referring now to FIG.1, a block diagram representation of one exemplary embodiment of a network architecture 100 including Long Term Evolution (LTE) cellular coverage 102 operating in conjunction with Wi-Fi coverage (e.g., IEEE 802.11n) 104 to provide network access is depicted. The LTE coverage area 102 operates within a network operator's licensed band, while the Wi-Fi hotspot (generated by the 4G wireless router 106) operates in the ISM (2 GHz) and/or U-NII (5 GHz) bands. As shown, the wireless router 106 establishes a first link 108 with the LTE network via its LTE UE-R (UE-Router or UE-R for short) module, and maintains a second link 110 via its LTE UE-S (UE-Subscriber) module to the user equipment (UE) 112. The UE 112 is a Wi-Fi-enabled LTE device (such as a smartphone).

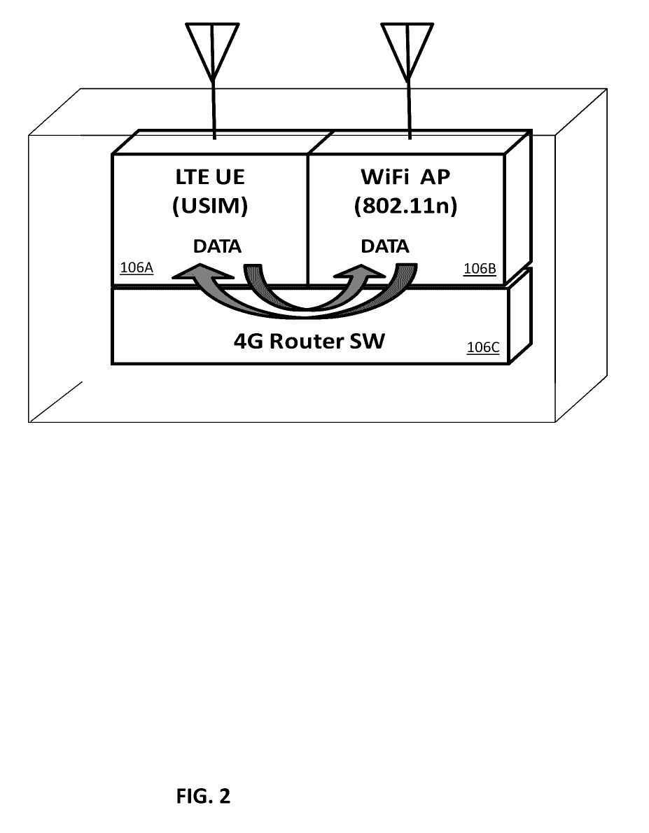

As shown in FIG. 2, the exemplary embodiment of the wireless router 106 includes three distinct modules: (i) a LTE UE-R (UE-Router) module 106A configured to communicate with the LTE eNB 114, (ii) a Wi-Fi AP module 106B configured to communicate with LTE UE-S (UE-Subscriber) module which is part of UE 112, and (iii) router software 106C configured to exchange data via the LTE UE-R 106A and Wi-Fi AP 106B modules via e.g., translation, flow control, etc. During operation, the wireless router 106 mediates between the LTE network eNB 114 and the UE 112. The wireless router 106 receives data packets from the eNB 114, converts them for transmission within the hotspot 104, and vice versa.

Advantages of the exemplary network architecture 100 of FIG. 1 include: (i) a reduction in the amount of licensed spectrum needed to support coverage, (ii) relatively low cost deployments (for both network and users), (iii) ad hoc deployment, and (iv) high throughput.

As a brief aside, spectrum (or bandwidth) is a rare and expensive resource cost for network operators. While most network operators own ˜10-20 MHz of bandwidth (at most), Wi-Fi networks operate within unlicensed frequency bands which span several hundred MHz of spectrum. A Wi-Fi system that supports Industrial, Scientific and Medical (ISM 2.4 GHz) and Unlicensed National Information Infrastructure (U-NII 5 GHz) bands will have access to approximately 80 MHz of spectrum at ISM and 450 MHz at U-NII bands (excluding outdoor bands). Initially, network operators were concerned about the availability and quality of a license-free (exempt) spectrum and possible negative impacts on user experience; however, unlicensed technologies (such as Wi-Fi) continue to provide stable and effective connectivity even under congested and hostile scenarios.

Unlike cellular technologies, the vast majority of existing Wi-Fi products are based on ad hoc deployments. Wi-Fi networks typically use Carrier Sense Multiple Access with Collision Avoidance (CSMA/CA) and contention-free (Point Coordination Function (PCF) or Distributed Coordination Function (DCF)) Medium Access Control (MAC) protocols specifically designed to enable ad hoc deployment. Ad hoc deployments reduce the network operator's burden for network planning, deployment and maintenance.

Still further, cellular technologies which were initially designed to support more egalitarian business models (e.g., provide a large number of subscribers with relatively low rate voice capability), Wi-Fi technology was designed to support high throughput from conception. Existing Wi-Fi devices are commonly capable of data rates in excess of 300 Mbits/sec; future revisions promise Gbits/sec data rates.

Wi-Fi technology and devices have been manufactured for more than a decade, and the components are commoditized and available at a relatively low cost. Many existing consumer devices already incorporate Wi-Fi technology, thus the minimal cost of equipment (for both network operators and subscribers) does not present any significant hurdle to deployment.

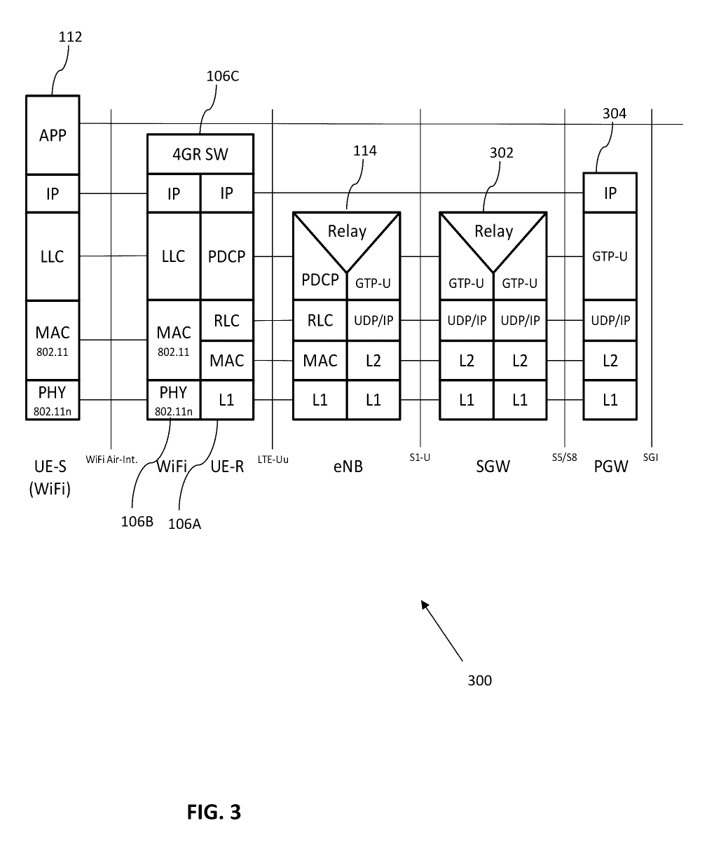

A short description of existing software is useful to illustrate why existing schemes for incorporating wireless routers within cellular networks suffer from certain disadvantages. Referring now to FIG. 3, a logical representation 300 of the various logical entities of the exemplary network architecture 100 is presented. As shown, the FIG. 3 includes five (5) logical entities: the subscriber UE (UE-S) 112, the wireless router 106, the LTE eNB 114, the Serving Gateway (SGW) 302, and the Public Data Network (PDN) Gateway (PGW) 304. Each logical entity is represented with a logical software stack representing the tiered nature of communications which is well understood within the arts. For example, the Medium Access Control (MAC) layer of the UE-S 112 communicates with the peer MAC entity of the wireless router 106, etc. The tiered nature of the communication stack is a common practical abstraction which is used to simplify software implementation. While the communication stack of FIG. 3 represents an illustrative example of a user-plane protocol stack configured to transact data bi-directionally, those of ordinary skill will appreciate that the depiction thereof is in no way limiting; other implementations are used in the related arts.

Within the context of FIG. 3, the point of termination of the LTE network is the LTE UE-R module 106A of the wireless router. In particular, the LTE UE-R module 106A is associated with a Universal Subscriber Identity Module (USIM) that uniquely identifies the wireless router 106 to the LTE network. The logical components outside of the point of termination (e.g., Wi-Fi AP module 106B, and the router software 106C) are unable to affect the cellular connection. More directly, the UE-S 112 is unaware of the requirements and capabilities of the underlying LTE connection 108 used by the wireless router 106.

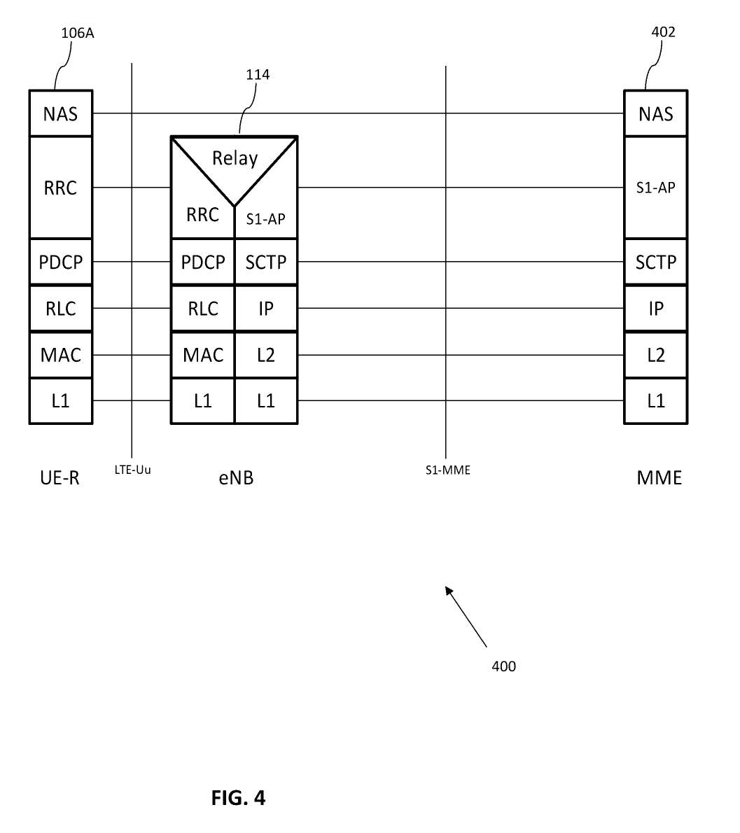

FIG. 4 illustrates a logical representation 400 of the various logical entities of the control-plane protocol stack associated with the data-plane protocol stack of FIG. 3. As illustrated in FIG. 4, the control-plane only extends between the LTE UE-R module 106A of the wireless router 106 and the Mobility Management Entity (MME) 402 of the LTE network. There are no UE-S 112 logical entities associated with the LTE control-plane protocol.

Due to this abstraction, the LTE UE-R 106A module may be configured generic radio bearers; these may be improperly matched to the requirements of the UE-S 112. For instance, the LTE UE-R may configure the LTE link for web browsing which is unable to support a UE-S 112 a streaming video application. This problem is further exacerbated when the wireless router is servicing multiple UE-S 112. For similar reasons, the wireless router uses its own USIM to access the LTE network. Since the USIM is associated with the wireless router (and not the subscriber), the LTE service is network specific (i.e., is limited to the network associated with the USIM) and billing is associated with the wireless router USIM (which is undesirable for public and communal operation). Further exacerbating subscriber control, the Wi-Fi hotspot security and access control options are limited. The Wi-Fi hotspot may either be left “open” (anyone can freely access the network) or alternatively require manual discovery, authentication and registration. Both configurations are not suitable for public and communal operation.

### Exemplary Network-agnostic Wireless Router—

As used herein, the term “network-agnostic” refers without limitation to devices which can operate on multiple networks; it is appreciated that the device itself may be limited to a set of networks by physical characteristics (e.g., physical transceivers, applicable software, etc.). For example, a device which can support either an LTE or CDMA connection but not WiMAX may be said to be “agnostic” with regards to LTE or CDMA.

In one exemplary embodiment according to the present disclosure, a network-agnostic wireless router does not require an identification module to provide network connectivity (e.g., a wireless router does not use a SIM/USIM to connect to a 3GPP network (e.g., LTE, UMTS, etc.), a RUIM/CSIM to connect to a CDMA network, etc.); instead, the network-agnostic wireless router provides an access tunnel or pipe that enables the subscriber to use their own identification module to connect to the appropriate network. As used herein, the term “access tunnel” or “pipe” refers to a networking technique of embedding a second access network within the network protocol stack of a first access network, so as to logically connect the connected first access network protocol layer to the following layer, via the connecting second access network, where the connecting second access network does not modify, alter, duplicate, delete, etc. the data payloads exchanged between the first access network protocol layer and the aforementioned following layer. Access tunneling enables delivery via mixed network technologies, delivery of secure data via unsecure networks, etc.

With regard to the exemplary embodiment of the access tunnel provided by the wireless router, transactions with the identity module of the subscriber are tunneled through the Wi-Fi hotspot and reproduced on the appropriate cellular air interface. Since the wireless router is providing the access tunnel in this embodiment, the authentication, authorization, and accounting mechanisms are all handled directly between the EPC network and subscriber's identity module (e.g., SIM, USIM, C SIM, RUIM, etc.) located on the UE-S 112, instead of the router's identity module. In fact, those of ordinary skill in the related arts will recognize that a wireless router so enabled by the present disclosure, may not require its own identity module (other than to e.g., support legacy modes, etc.).

Similarly, since the network-agnostic wireless router is not registered to any single network operator, the wireless router is free to support multiple different networks (e.g., Public Land Mobile Network (PLMNs)) simultaneously (certain legal and/or contractual limitations may prohibit devices from registering on multiple networks simultaneously). For example, using the Wi-Fi hotspot capabilities the network-agnostic wireless router can tunnel access to an LTE network and a CDMA network at the same time, allowing multiple subscribers of different networks to use the same hotspot.

Finally, since the network-agnostic router is merely access tunneling the subscriber's device transactions, the subscriber device maintains control-plane access in the illustrated embodiment. Control-plane access enables the subscriber device to properly manage service requirements e.g., Quality of Service (QoS), etc. For example, a mobile device that is attempting to stream a video can instruct the LTE network appropriately; it is of particular note that since prior art wireless routers were unaware of application requirements, prior art routers were unable to effectively negotiate QoS requirements for its serviced devices.

As described in greater detail hereinafter (see e.g., Exemplary Subscriber Device, infra), various embodiments of the present disclosure may be used in conjunction with middle-ware software located in the subscriber UE (UE-S) or other device. In some embodiments, the middle-ware software can be downloaded (e.g., by the user, or a provisioning service or technician or entity); alternatively, the middle-ware software may be pre-loaded during device manufacture. In still other embodiments, various embodiments of the present disclosure may be used in conjunction with subscriber devices which include specialized hardware to support the appropriate functionality.

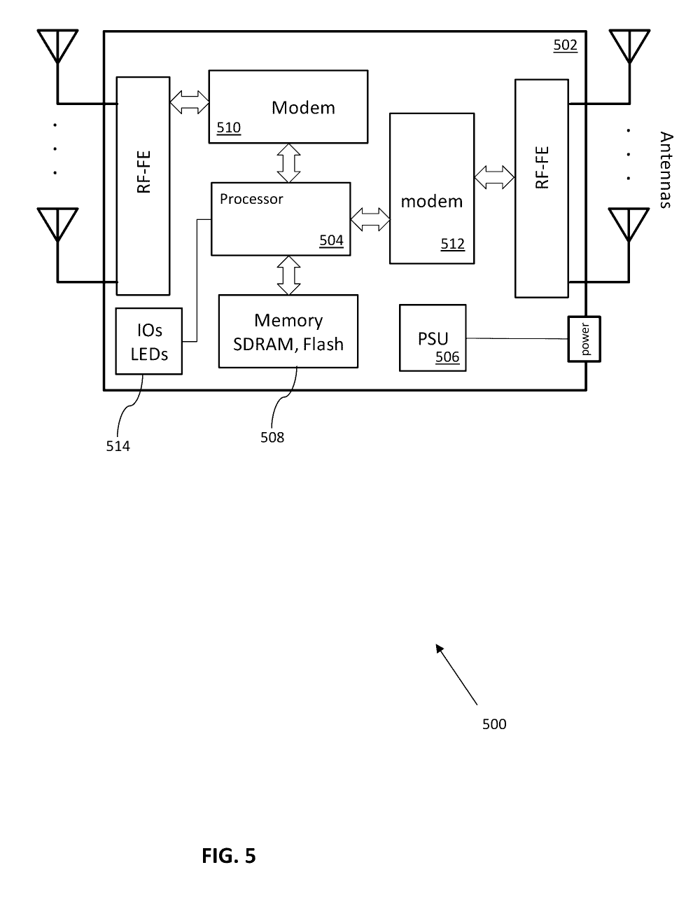

Referring now to FIG. 5, one exemplary embodiment of a network-agnostic wireless router 500 configured to provide network connectivity is presented.

In one embodiment, the network-agnostic wireless router 500 is a standalone device, however those of ordinary skill in the related arts will recognize that the described functionality may be incorporated in a wide variety of devices including without limitation: a smartphone, portable computer or tablet, desktop computer, wireless dongle or USB key, etc.

The exemplary apparatus 500 includes one or more substrate(s) 502 that further include a plurality of integrated circuits including a processing subsystem 504 such as a digital signal processor (DSP), microprocessor, programmable logic device (PLD), gate array, or plurality of processing components as well as a power management subsystem 506 that provides power to the apparatus 500, a memory subsystem 508, and a first radio modem subsystem 510 and a second radio modem subsystem 512. In some embodiments, user input/output (I/O) 514 may also be present.

In some cases, the processing subsystem may also include an internal cache memory. The processing subsystem 504 is connected to a memory subsystem 508 including non-transitory computer-readable memory which may, for example, include SRAM, Flash and SDRAM components. The memory subsystem may implement one or a more of DMA type hardware, so as to facilitate data accesses as is well known in the art. During normal operation, the processing system is configured to read one or more instructions which are stored within the memory, and execute one or more actions based on the read instructions.

The illustrated power management subsystem (PMS) 506 provides power to the network-agnostic wireless router 500, and may include an integrated circuit and or a plurality of discrete electrical components. Common examples of power management subsystems 506 include without limitation: a rechargeable battery power source and/or an external power source e.g., from a wall socket, inductive (wireless) charger, etc.

The user I/O 514 includes any number of well-known I/O including, without limitation: LED lights, speakers, etc. For example, in one such case, a set of LEDs can be used to indicate connection status (e.g., “green” indicates an online status, “red” indicates a malfunction or connectivity issue, etc.). In more complex embodiments, the I/O may incorporate a keypad, touch screen (e.g., multi-touch interface), LCD display, backlight, speaker, microphone, or other I/Os such as USB, GPIO, RS232 UART, PCI, GMII, RGMII, etc.

The first radio subsystem is 510 is configured to connect to one or more first networks. In one exemplary embodiment, the first networks are configured to provide network connectivity to e.g., the Internet, etc. The first radio subsystem 510 is configured to establish a data-capable link via a cellular network. Common examples of data capable cellular technologies include without limitation: Long Term Evolution (LTE), LTE-Advanced (LTE-A), Universal Mobile Telecommunications System (UMTS), General Packet Radio Service (GPRS), CDMA2000, CDMA 1X-EVDO, etc. While cellular networks are generally discussed herein, it is appreciated that the various aspects of the present disclosure are not limited to such networks. Other common examples of wireless networks which may provide similar services include e.g., WiMAX, Wi-Fi, Bluetooth, Wireless Metropolitan Area Networks (WMANs), etc.

Those of ordinary skill in the related arts will readily appreciate that certain wireless technologies may implement access control (e.g., authentication, authorization, or accounting, etc.). For example, for 3GPP networks (e.g., LTE, LTE-A, UMTS, etc.) subscriber devices must successfully complete an Authentication and Key Agreement (AKA) process. The AKA procedure is based on a shared secret which is stored within a secure SIM card of the subscriber device and at the network authentication center (AuC). The SIM and AuC perform a challenge and response test, successful mutual authentication results in a secure association between the SIM and serving system.

The second radio subsystem is 512 is configured to generate a wireless network that is configured to accept one or more subscriber devices. In one exemplary embodiment, the generated wireless network is an “open” network i.e., the generated wireless network does not require any access control measures (e.g., authentication, authorization, or accounting, etc.). While open network operation is described herein, it is appreciated that access control schemes need not be open; limited access (i.e., partially open), and “closed” access may be used with equal success, and even intermingled or combined for various scenarios. In fact the credentials and secret key(s) for wireless radio subsystem 512 can be entered and set via the cellular radio subsystem 510 that exists between the UE-S and the core network as it is a secure link, and then transferred from the core network through LTE-R interface to Wi-Fi part 512, as again, this is the same secure link. In one exemplary embodiment, the generated wireless network includes a Wi-Fi network. Other wireless technologies may incorporate e.g., Bluetooth, WiMAX, etc. In some cases, the open networks may incorporate so-called “ad hoc” networking, (i.e., unplanned or unstructured establishment of relationships between two or more entities or devices), so-called “mesh” networking, etc. Hence, the present disclosure contemplates use of an aggregation or even daisy-chaining of heterogeneous and/or homogeneous network types.

In one exemplary embodiment, the first radio subsystem 510 is configured only as a pass-through wireless connection for data which is received via the second radio subsystem 512. During “pass-through” operation, the data payload that is received via the second radio subsystem 512 is passed to the first radio subsystem 510 for transmission without modification, etc. Similarly, the data payload that is received via the first radio subsystem 510 is passed to the second radio subsystem 512 for transmission without modification. It is of note that the data payload is likely encrypted between the endpoints (e.g., the network and the subscriber device), and thus the network-agnostic wireless router 500 would not be able to intercept messages anyway. As will be readily appreciated by those of ordinary skill in the related arts given the present disclosure, the data payload is encapsulated within the appropriate radio link specific control data; as a point of clarification, the radio link specific data is managed by the network-agnostic wireless router. Radio link specific information is generally configured to communicate with corresponding radio link layers in peer entities which may include e.g., the physical and MAC layers, the data link layer, and possibly elements of the network and transport layers. The physical layer manages the physical modulation and transmission of data and may include information such as power control, frequency correction, time correction, etc, while the MAC layer formats the packets and controls access to the physical layer medium. The data link layer manages the physical reliability of a data transmission and includes e.g., error detection and correction, etc. The network layer manages the delivery of data according to addresses within a network, while the transport layer ensures that data is reliably delivered.

Moreover, one secure scheme for data delivery to the network-agnostic wireless router 500 relies on delivery from a certified authority via the first radio subsystem 510. Specifically, the credentials for wireless radio subsystem 512 can be entered and set via the cellular radio subsystem 510 that exists between the UE-S and the core network (which is a secure link), and then transferred from the core network through LTE-R interface to Wi-Fi part 512 (via the same secure link).

Referring back to the processing subsystem 504 of FIG. 5, the processing system requires sufficient processing capability to support the first radio subsystem 510 and second radio subsystem 512 simultaneously. As shown in FIG. 5, there are several (2 or more) antennas to support MIMO operation of the first and second networks (e.g., LTE and IEEE 802.11n, respectively). While not expressly shown, it is appreciated that each RF frontend includes e.g., filters, duplexers, RF switches, RF signal power level monitoring, LNA (Low-Noise Amplifier) and PAs (Power Amplifier) that may be required for the device's radio subsystem.

In one exemplary embodiment, the second radio subsystem 512 includes all the functionalities needed to configure and operate an IEEE 802.11n modem, including the transceiver part, PHY (physical layer) and MAC (Median access Controller) units, as well as all the associated control and operation SW. An example of such unit is a Broadcom 802.11n single chip product, BCM4322 or BCM4323, although others may be used with equal success.

In one exemplary embodiment, the processor subsystem 504 is configured to execute software for operation and control of the network-agnostic wireless router. An example of such unit is Broadcom BCM4705 processor chip which includes a processor core and a number of I/O functions such as GPIO, RS232 UART, PCI, GMII, RGMII as well as DDR SDRAM controller or Snapdragon 800 manufactured by Qualcomm Corporation.

In one exemplary embodiment, the first radio subsystem 510 includes all the functionality necessary to configure and operate a 4G LTE modem. An example of such a device is the QUALCOMM Gobi MDM9600 and its associated RF and peripheral chips. In some embodiments, a SIM/USIM module may be included to provide the option of operating in the conventional wireless router mode as well.

Many existing chipsets (e.g., the QUALCOMM Gobi MDM9600) are only configured to support a single subscriber; those of ordinary skill in the related arts will readily appreciate that such limitations are present within these existing chipsets, and would not be present otherwise (i.e., there is no inherent limitation to a number of users supported by the network-agnostic wireless router). However, where it is desirable to support multiple subscribers with the network-agnostic wireless router using existing available market chipsets, one possible solution is to implement a 1:1 ratio of chipsets to supportable users. In other words, a wireless router with two (2) LTE modem units (e.g., QUALCOMM Gobi MDM9600 chip and all its associated RF and peripheral chips and components) can support up to two (2) distinct users. Alternatively, more specialized hardware/software can be developed to facilitate a one-to-many type relationship (e.g., one modem unit that services multiple discrete users).

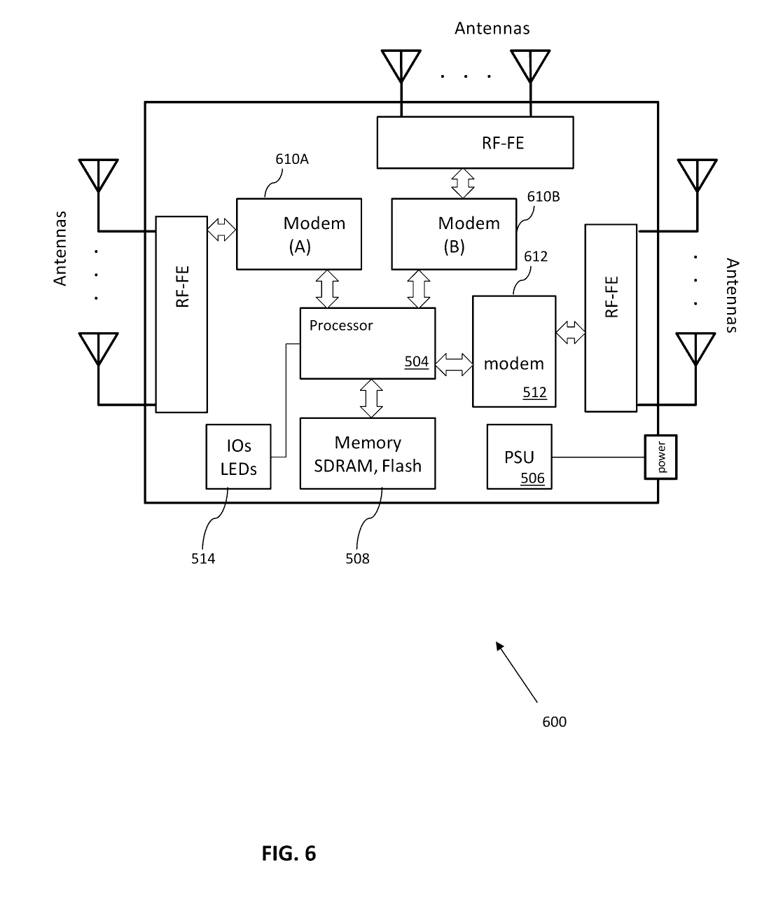

FIG. 6 shows one illustrative example of a dual-user and/or dual-band network-agnostic wireless router 600 with two LTE modems (610A, 610B), that can be tuned to two different LTE bands (or the same band). For example, two different LTE network carriers operating in the same vicinity will have distinct frequency bands; the hotspot provided by the network-agnostic wireless router can provide access to either network for up to two users. Similarly, even where both of the two LTE modems (610A, 610B) are tuned to the same network, transactions with the first user can be provided on the first modem 610A, transactions with the second user can be provided on the second modem 610B. The traffic is multiplexed and provided via standard multiple access schemes for the hotspot using the Wi-Fi modem 612.

In another such solution, the PHY operations for different users can be modified and integrated within a single PHY implementation, connected to a virtualized user MAC and higher layers. Such an implementation requires significant processing power at the network-agnostic wireless router 500 as each distinct user requires a separate virtualized memory space (e.g., protocol stack, MAC, etc.), within the network-agnostic wireless router. One such embodiment incorporates support of several users on a single multi-core processor, such as for example the Freescale QorIQ Qonverge B4420 Baseband Processor.

### Exemplary Subscriber Device—

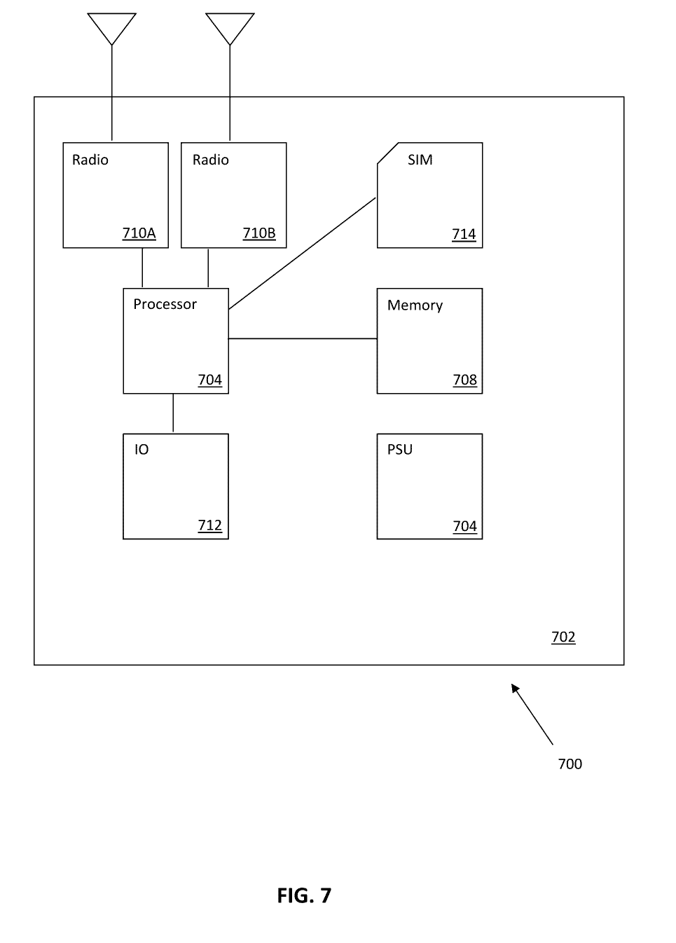

Referring now to FIG. 7, one exemplary embodiment of a subscriber device 700 configured to connect to the network-agnostic wireless router of FIG. 5 is presented. In one implementation, the subscriber device 700 is a dedicated device, however those of ordinary skill in the related arts will recognize that the described functionality may be incorporated in a wide variety of devices including without limitation: a smartphone, portable computer, tablet, desktop computer, server blade, etc. and even standalone devices with only one radio modem for Wi-Fi 802.11n communications, etc.

The exemplary apparatus 700 includes one or more subunit(s) 702 that further include a plurality of integrated circuits including a processing subsystem 704 such as a digital signal processor (DSP), microprocessor, programmable logic device (PLD), gate array, or plurality of processing components as well as a power management subsystem 706 that provides power to the apparatus 700, a memory subsystem 708, and two radio modems subsystem 710a and 710b, one for LTE air-interface and one for Wi-Fi IEEE 802.11n air-interface. In some embodiments, user input/output (I/O) 712 may also be present.

In some cases, the processing subsystem may also include an internal cache memory. The processing subsystem 704 is connected to a memory subsystem 708 including non-transitory computer-readable memory which may, for example, include SRAM, Flash and SDRAM components. The memory subsystem may implement one or a more of DMA type hardware, so as to facilitate data accesses as is well known in the art. During normal operation, the processing system is configured to read one or more instructions which are stored within the memory, and execute one or more actions based on the read instructions.

The illustrated power management subsystem (PMS) 706 provides power to the subscriber device 700, and may include an integrated circuit and or a plurality of discrete electrical components. Common examples of power management subsystems 706 include without limitation: a rechargeable battery power source and/or an external power source e.g., from a wall socket, inductive charger, etc.

The user IO 712 includes any number of well-known IO common to consumer electronics including, without limitation: a keypad, touch screen (e.g., multi-touch interface), LCD display, backlight, speaker, and/or microphone or USB and other interfaces.

The radio subsystem is 710 is configured to tunnel to a network operator via a wireless access network generated by the network-agnostic wireless router 500 (see e.g., FIG. 5). In one exemplary embodiment, the generated wireless network is an “open” network i.e., the generated wireless network does not require any access control measures (e.g., authentication, authorization, or accounting, etc.). While open network operation is described herein, it is appreciated that access control schemes need not be open; partial or limited access, and closed access may be used with equal success, as well as combinations or variations of the foregoing. In one exemplary embodiment, the generated wireless network includes a Wi-Fi network using an IEEE 802.11n access technology. Other wireless technologies may be incorporated, Bluetooth, WiMAX, etc. In some cases, the open networks may incorporate so-called “ad hoc” networking, mesh networking, etc. as previously described.

While one radio subsystem is illustrated, it is readily appreciated that most commercial implementations will include additional radio subsystems (which are not shown as a matter of clarity). For instance, in one exemplary case, the subscriber device additionally includes a cellular radio subsystem for connecting to a cellular network provisioned by a network operator via existing legacy cellular technologies.

In one exemplary embodiment, the subscriber device is further associated with an identification module 714 that verifies the subscriber device to the network operator. Generally, identification module securely identifies the subscriber device (or subscriber account associated with the device) as being authentic and authorized for access. Common examples of identification modules include without limitation, SIM, USIM, RUIM, CSIM, etc. In some cases, the identification modules 714 may be removable (e.g., a SIM card), or alternatively an integral part of the device (e.g., an embedded element having the identification module programmed therein).

In one exemplary embodiment, the radio subsystem 710 is configured for operation in conjunction with a pass-through wireless connection for data payloads (provided by e.g., the network-agnostic wireless router 500 described in FIG. 5, supra). During “pass-through” operation, received data includes “access tunneled” data payloads that are addressed for a logical entity of the subscribed device. In one exemplary embodiment, the access tunneled data payload includes communications from the authentication center (AuC) of the LTE network (which has been encapsulated within a Wi-Fi hotspot of the network-agnostic wireless router), the data payload being configured for operations (such as the aforementioned Authentication and Key Agreement (AKA) procedure) with the logical entities disposed on a SIM card of the subscriber device.

Those of ordinary skill in the related arts will appreciate that the subscriber device may have multiple other components (e.g., multiple additional radio subsystems, graphics processors, etc.), the foregoing merely illustrative.

### Exemplary “Wi-Fi PIPE”—

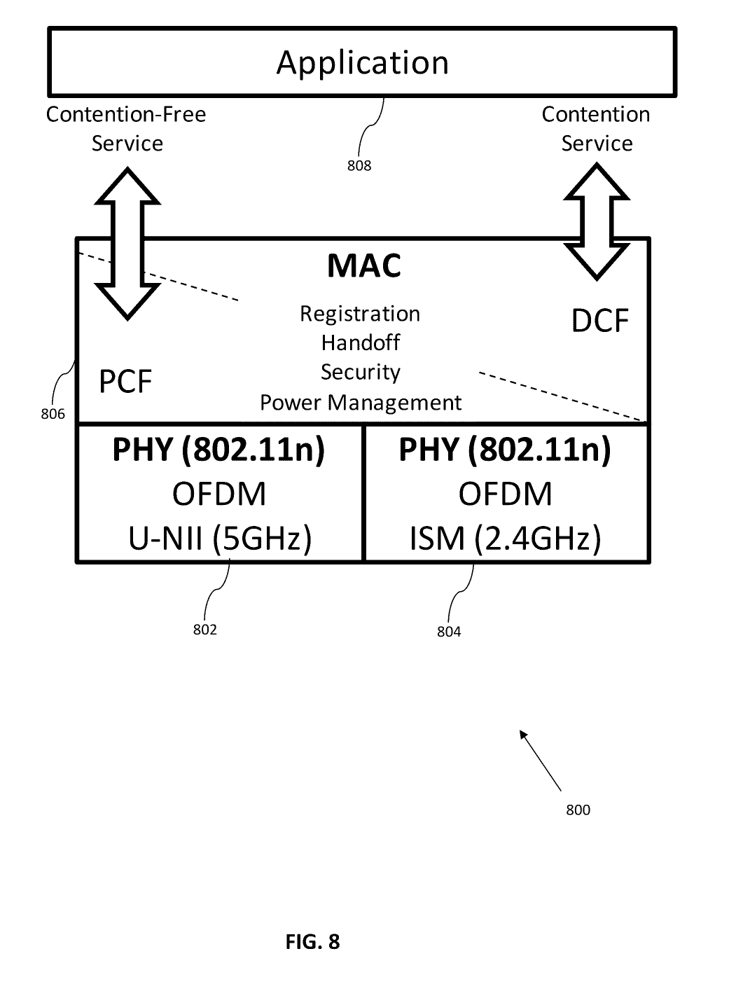

FIG. 8 illustrates a logical block diagram representing one embodiment of an IEEE 802.11n PHY (L1) and MAC (L2) protocol stack 800 useful in conjunction with various aspects of the present disclosure. As shown, the application software 808 operates directly above the MAC layer 806. It is appreciated that other variants may incorporate other software layers (e.g., a Logical Link Control (LLC) and/or IP layer) based on design considerations. The illustrative PHY can operate in either the U-MI band 802 or ISM band 804, or both at the same time.

The MAC layer 806 can either be set to operate in the “Contention” or “Contention-Free” mode. In contention-free operation, the MAC uses a Point Coordination Function (PCF); during contention mode operation, the MAC uses a Distributed Coordination Function (DCF). Other Wi-Fi MAC functions include registration, hand-off, power management, security and Quality of Service (QoS). Where not otherwise stated herein, existing Wi-Fi components and functionality are well understood within the related arts and not discussed further.

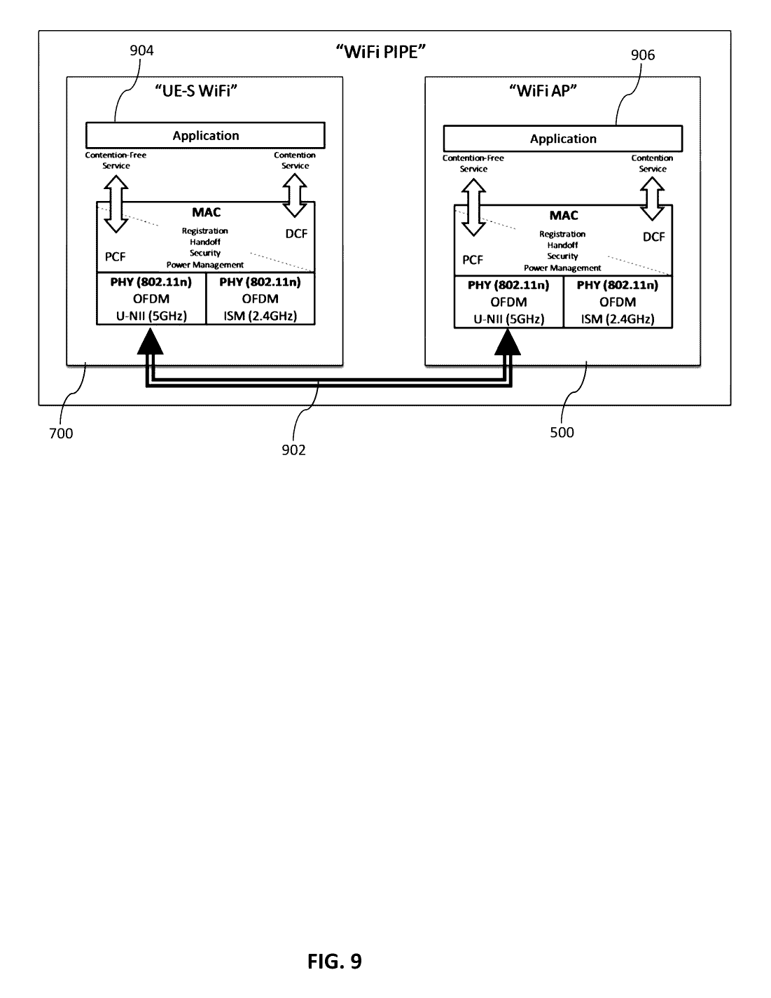

Referring now to FIG. 9, consider the exemplary network-agnostic wireless router 500 (e.g., as described in FIG. 5 and discussion supra) and the exemplary subscriber device 700 (e.g., as described in FIG. 7 and discussion supra). Once the exemplary subscriber device 700 enters the exemplary network-agnostic wireless router 500 coverage area and registers with the open network, the end-to-end MAC connection between the subscriber device 700 and the wireless router 500 forms a “transparent” connection pipe (or access tunnel) which is termed hereafter a “Wi-Fi PIPE' 900. In some embodiments, the Wi-Fi PIPE tunnel itself is unsecure (e.g., where the hotspot behaves as an “open” Wi-Fi network), and the underlying data payloads may be protected according to existing encryption schemes that are used end-to-end for the cellular (LTE) network and/or at the application layer, etc. such as those used over traditional untrusted networks. In other embodiments, The Wi-Fi PIPE is implemented via a closed network and incorporates native encryption, etc. (Wired Equivalent Privacy (WEP), Wi-Fi Protected Access (WPA), WPA2, etc.). One exemplary Wi-Fi PIPE is described in greater detail within commonly owned and co-pending U.S. patent application Ser. No.: 14/156,339, entitled “METHODS AND APPARATUS FOR HYBRID ACCESS TO A CORE NETWORK”, filed Jan. 15, 2014, incorporated herein by reference in its entirety.

The exemplary implementation of the Wi-Fi PIPE enables the two logical endpoints running a first application 904 and a second application 906 (respectively) to communicate directly without any intervening translation (i.e., data transfers are not modified). The logical endpoints can be unaware of the underlying physical and data link transactions which are occurring in their respective Wi-Fi interfaces. In one exemplary embodiment, the first application 904 is coupled to the UE-S software stack, and the second application 906 is coupled to the UE-R stack (not shown). In other words, the exemplary Wi-Fi PIPE enables the UE-S stack (the SIM/USIIVI card on the subscriber device 700) to logically appear directly connected to the UE-R protocol stack (on the network-agnostic wireless router 500).

Referring back to the Wi-Fi PIPE, in one implementation, the Wi-Fi PIPE is inserted into the UE-S LTE protocol stack, replacing one or more layers of the UE-S LTE protocol stack, connected on one side to the UE-S LTE stack layer which is just above the removed layers, and on the other side, the Wi-Fi PIPE is connected to UE-R LTE protocol stack, which is also providing the functionalities of the layers that were replaced in UE-S LTE protocol stack. The two L 1E protocol stacks in UE-S and UE-R together provide the full LTE protocol stack that is needed for an LTE handset to operate correctly in an LTE network. The Wi-Fi PIPE effectively provides access tunneling between two layers of LTE UE protocol stack wirelessly.

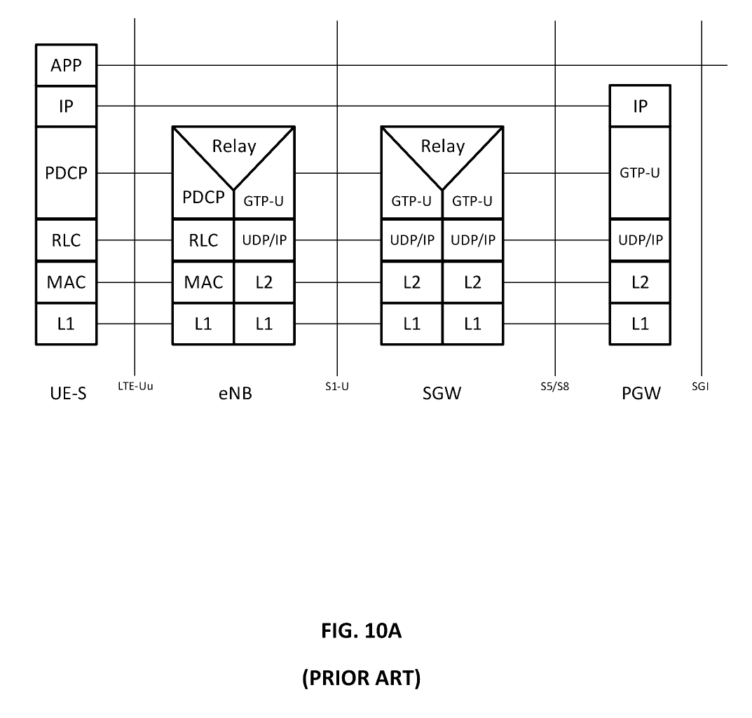

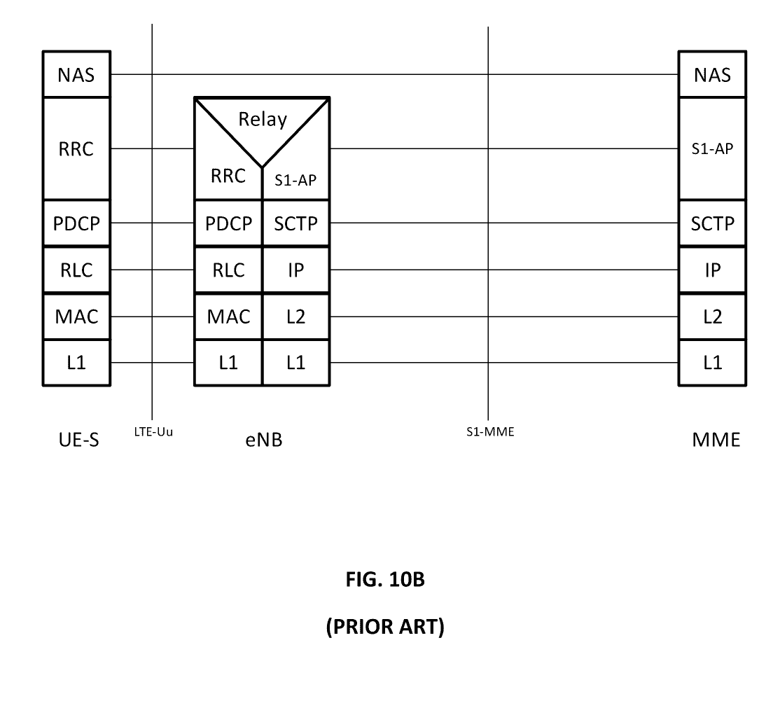

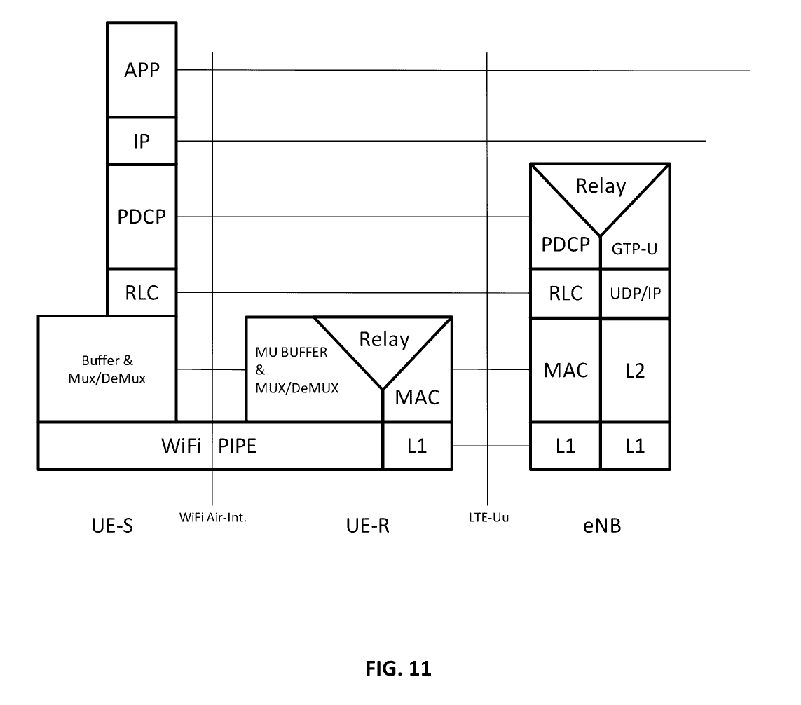

FIG. 10A illustrates a prior art LTE software user-plane protocol stack, and FIG. 10B illustrates a prior art LTE software control-plane protocol stack. In contrast, FIG. 11 illustrates one exemplary hybrid Wi-Fi PIPE protocol stack operating beneath the Radio Link Control (RLC) layer, and which has replaced the LTE MAC and L1 layers. The replaced LTE MAC and L1 layers are supported by the UE-R stack in the network-agnostic wireless router 500.

In one implementation, the Wi-Fi PIPE is coupled to First-In-First-Out (FIFO) data buffers on both sides (e.g., at the subscriber device 700 and the router 500) to handle time of arrival issues (e.g., jitter) which might otherwise cause scheduling problems for the Wi-Fi PIPE or LTE operation. In multiple user embodiments, the router may incorporate multiple buffers corresponding to each user, a single buffer which is divided into multiple partitions for each user, etc.

There is one RLC entity for each radio bearer; this enables multiple radio bearers with isolate radio bearer performance. The LTE RLC is configured to disassemble (and re-assemble) data packets from (and to) the Packet Data Convergence Protocol (PDCP) layer into manageable sizes for the Wi-Fi PIPE. The LTE RLC is further configured to ensure that all received packets are in order before passing them to the PDCP layer. In the event that a packet is lost, the LTE RLC layer can perform re-transmission to recover lost packets by initiating Automatic Repeat Request (ARQ) procedures.

There is one PDCP entity per radio bearer (which ensures isolated radio bearer performance). The LTE PDCP entity is configured to provide the ciphering (and integrity) protection (over untrusted connections, such as the Wi-Fi PIPE). The LTE PDCP is further configured to provide Robust Header Compression (ROHC) which may reduce the overhead of transmitting small packets (further improving Wi-Fi PIPE performance). Finally, the PDCP entity can provide reordering and re-transmission of packets during hand-off operation.

While the foregoing discussion and FIG. 11 depict the Wi-Fi PIPE functionality at the MAC and L1 layers, it is appreciated that other embodiments may implement equivalent access tunnel type operations at any layer of the subscriber device and/or network-agnostic wireless router device.

The foregoing discussion is based on the Wi-Fi PIPE data throughput being sufficiently larger than the data throughput required by the LTE network to support all users in the coverage area. While the foregoing assumption is generally true, it is appreciated that where the LTE network operates at a faster speed than the hotspot, the Wi-Fi PIPE should indicate the available capacity to the LTE network such that the LTE network can make appropriate adjustments to the radio bearers (e.g. resource and bandwidth allocation to each UE-S MAC is limited). Such scenarios may occur where the network-agnostic wireless router offers both cellular network connectivity and simultaneous legacy wireless router operation; the two functions may be “capped” at a certain proportion of the routers bandwidth to ensure that both functions are sufficiently supported.

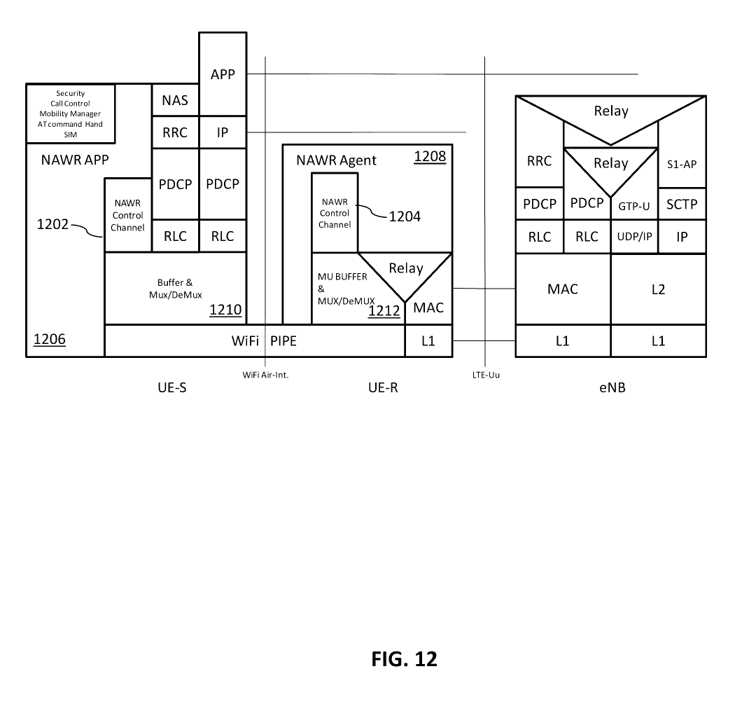

Referring now to FIG. 12, the overall protocol stack architecture (both user-plane and control-plane) for the subscriber device and the network-agnostic wireless router is presented. The two-way auxiliary control channels (1202, 1204) and the supporting application and agent (1206, 1208) are called the Network-agnostic Wireless Router (NAWR) protocol stack.

As shown, the NAWR APP (application) 1206 resides in the subscriber device and includes an LTE stack that includes the radio link control (RLC) to non-access stratum (NAS) for control-plane, and RLC to internet protocol (IP) for user-plane operations. The NAWR APP also includes the Buffer and MUX/DeMUX, as well as the NAWR Control Channel and control and operation software. The counterpart NAWR agent 1208 resides in the network-agnostic wireless router and includes a LTE UE-S MAC and PHY entities which are now supported at the UE-R, which handles control-plane, user-Plane, SRB, DRBs, and NAWR Control Channel packets for one or more subscriber devices. The NAWR APP and NAWR Agent communicate bi-directionally over the NAWR Control Channel.

In one embodiment, the NAWR APP is a downloadable application (e.g., for purchase) and/or included in the subscriber device during manufacture. Depending on the nature of software implementation and accessibility of 3^{rd} party support for the indigenous LTE software, the NAWR APP can replace in whole or part, the indigenous LTE protocol stack during operation. For instance, due to security concerns, the NAWR APP may have its own copy of the relevant LTE protocol stack; in other embodiments, the NAWR APP may be configured to interface with supported LTE protocol stacks.

Referring now to the Buffer and MUX/DeMUX 1210, the Buffer and MUX/DeMUX 1210 is configured to multiplex RLC packets of different signaling radio bearer (SRBs), data radio bearers (DRBs), control-plane, user-plane, and NAWR Control Channel packets into a single stream for delivery via the Wi-Fi PIPE in the uplink. On the downlink, the Buffer and MUX/DeMUX 1210 is configured to buffer the incoming data and de-multiplex packets to the appropriate SRBs, DRBs, control-plane, user-plane, and NAWR Control Channel.

Similarly, the multiple user (MU) Buffer and MUX/DeMUX 1212 of the NAWR Agent is configured to multiplex different users' MAC packets (which includes SRB & DRB), and packets from their corresponding NAWR Control Channel into a single stream before buffering and delivering it to Wi-Fi PIPE for transmission to the subscriber. On the uplink, the MUX/DeMUX 1212 is configured to buffer and demultiplex packets (from multiple users) delivered via the Wi-Fi PIPE, before passing it to respective LTE MAC and PHY entities corresponding to the subscriber. Every subscriber attached to the network via the NAWR agent has a unique instance of a corresponding NAWR protocol stack.

### Methods—

The exemplary Wi-Fi PIPE between the NAWR APP 1206 and NAWR Agent 1208 is self contained. The Wi-Fi link is managed without input from external entities. Additionally, certain aspects of the LTE radio link (between the network-agnostic wireless router and the eNB) may affect certain aspects of the hotspot operation (between the network-agnostic wireless router and the subscriber device). For this reason, link management is divided into three (3) logical functions:
a) Wi-Fi PIPE management when in the coverage area which further may include:
   a. configuration of the Wi-Fi PIPE, monitoring and maintaining the operation of the Wi-Fi PIPE according to radio link performance; and
   b. acquisition and configuration of an LTE session with the Evolved Packet Core (EPC) network that is configured to provide sufficient throughput for the Wi-Fi PIPE;
b) LTE link management which generally includes:
   a. decode of system information;
   b. paging channel operation;
   c. cell measurement and responsive cell reselection and hand-off procedures;
   d. radio resource control (RRC);
   e. security, integrity, access control (e.g., via SIM);
   f. call control;
   g. mobility control; and
c) NAWR session initiation;
   a. discovery, initiation and configuration of the NAWR session (e.g., for hotspots which support both NAWR and legacy operation).

In more detail, the Wi-Fi PIPE management controls the wireless connectivity between the subscriber device and network-agnostic wireless router. In one embodiment, Wi-Fi hotspot functionality is based on legacy components operating according to e.g., existing IEEE 802.11n specifications; in other embodiments, the Wi-Fi hotspot functionality may be integrated with the NAWR APP and/or NAWR Agent to optimize performance for use specific to the Wi-Fi PIPE. For example, the NAWR Agent can monitor the performance on the LTE link, and use the monitored performance to inform Wi-Fi PIPE operation. By coordinating channel and bandwidth assignments, the NAWR Agent can reduce the amount of buffering and/or provide better quality (e.g. low latency and low jitter) links configured for services such as VoLTE (Voice over LTE) or VoIP (Voice over IP). It is appreciated that certain operations may not directly affect the radio link (e.g., Wi-Fi registration, Intra-Wi-Fi hand-off, Wi-Fi Power management and Wi-Fi QoS, etc.); depending on implementation, these features can be handled within either legacy components and/or the NAWR APP/Agent.

With regards to the LTE link management, the NAWR Agent and/or APP manage the network connectivity between the subscriber device (UE-S) and a network operator's Evolved Packet Core (EPC) network. In one embodiment, LTE network connectivity is based on legacy components operating according to e.g., existing LTE specifications; in other embodiments, the LTE link functionality may be integrated with the NAWR APP and/or NAWR Agent to optimize performance for use specific to the Wi-Fi PIPE. As previously alluded to, the performance of the LTE link can be monitored to improve Wi-Fi PIPE operation. Similarly, operations which may not directly affect the L 1E performance may be handled by legacy components, or incorporated within the NAWR Agent and/or APP. Common examples include, without limitation: LTE network acquisition (selection and reselection), Authentication, Encryption, Integrity Protection, Call Control (call/session set-up/tear-down), Mobility (Intra and Inter L I L hand-off), etc.

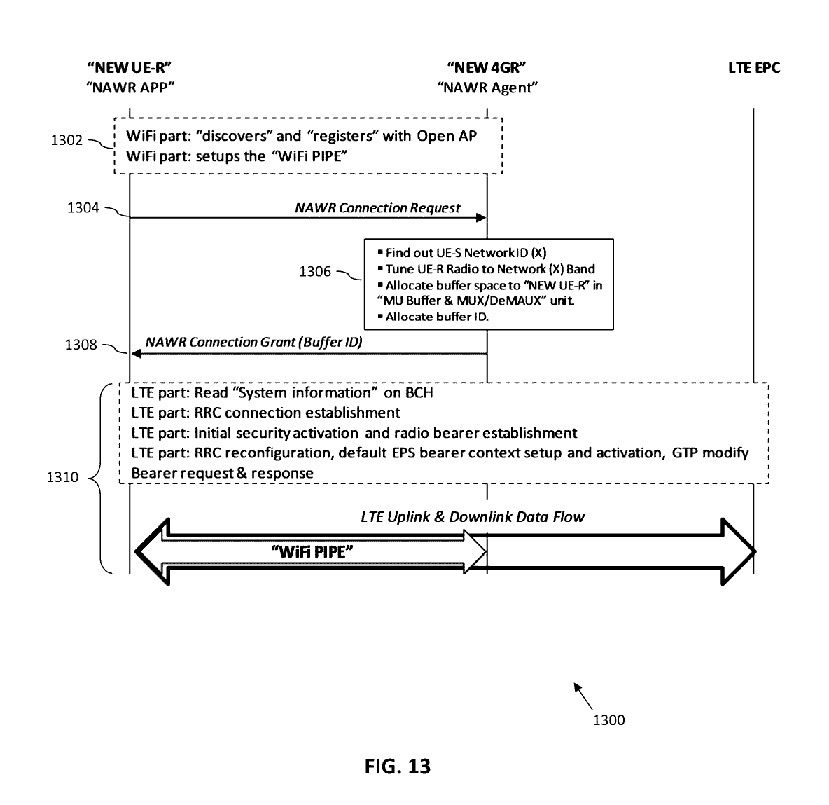

With regards to mobility management, one embodiment of a generalized process for discovery, initiation and configuration of a session is depicted within FIG. 13. As shown, the NAWR APP and/or NAWR Agent are configured to discover, initiate and configure the NAWR session and Wi-Fi PIPE.

At step 1302 of the process 1300, a subscriber device discovers an enabled wireless network. The subscriber device determines whether the wireless network supports network-agnostic operation. Common examples of discovery include without limitation: decoding control broadcasts, direct inquiry, etc.

In some variants, the wireless network is an “open” network. Open networks do not have restrictive access controls (e.g., authentication, authorization, etc.). In other networks, the network may be closed, partially limited, etc. For example, the subscriber device may be required to prompt the user for a password or to press a button on the wireless router, etc. In still other cases, the subscriber device may be allowed access via out-of-band procedures (e.g., allowed by an administrator, etc.). Various other suitable schemes are appreciated by those of ordinary skill within the related arts, given the contents of the present disclosure.

At step 1304, when the subscriber device determines that the wireless network supports network-agnostic operation, the NAWR APP attempts to establish an access tunnel (or NAWR session) between the subscriber device and a network operator via the network-agnostic wireless router. In one embodiment, the access tunnel includes a Wi-Fi PIPE between a UE-subscriber (UE-S) and the network-agnostic wireless router. In one such example, a NAWR APP (or NAWR Agent) transmits a NAWR Connection Request via a NAWR Control Channel; the Connection Request includes information pertinent to connection establishment. Common examples of information include e.g., software version, subscriber device network operator identification and frequencies (e.g., one or more LTE networks the subscriber's SIM is configured for), a list of Wi-Fi and LTE neighbors, etc.

At step 1306 of the process 1300, responsive to reception of the Connection Request, the NAWR Agent determines whether a NAWR connection can be established. In some cases the NAWR Agent may be unable to support the connection request due to resource limitations (e.g., lack of memory, insufficient processing power, unable to access network operators, etc.). If the NAWR Agent can support the connection request, then the NAWR Agent configures a radio front end according to the Connection Request; otherwise the connection request fails. In one exemplary embodiment, the NAWR Agent configures a LTE RF operating frequency.

Additionally, the NAWR Agent allocates or reserves memory for the data stream buffering corresponding to the subscriber device. In one embodiment, a portion or partition of the MU Buffer & MUX/DeMUX buffer of the NAWR Agent is reserved and issued a Buffer ID (Handler). The Buffer ID is provided to the NAWR APP, and thereafter the UE-S NAWR APP will use the Buffer ID to access/modify its corresponding NAWR connection (the NAWR Agent may be handling multiple distinct subscribers simultaneously).

At step 1308, if the NAWR connection request was successful, then the NAWR Agent provides the connection parameters back to the NAWR APP via a NAWR Connection Grant. In one implementation, the connection parameters include the Buffer ID. Other common examples of connection parameters may include e.g., quality of the connection, maximum data rate and/or throughput, minimum data rate and/or throughput, latency, other connection limitations (e.g., QoS), etc.

At step 1310, thereafter the subscriber device can transact data via the NAWR connection. More generally, the subscriber device can perform “access tunneled” LTE operation e.g., system acquisition, connection establishment, activation, radio bearer establishment, and data flow, etc.

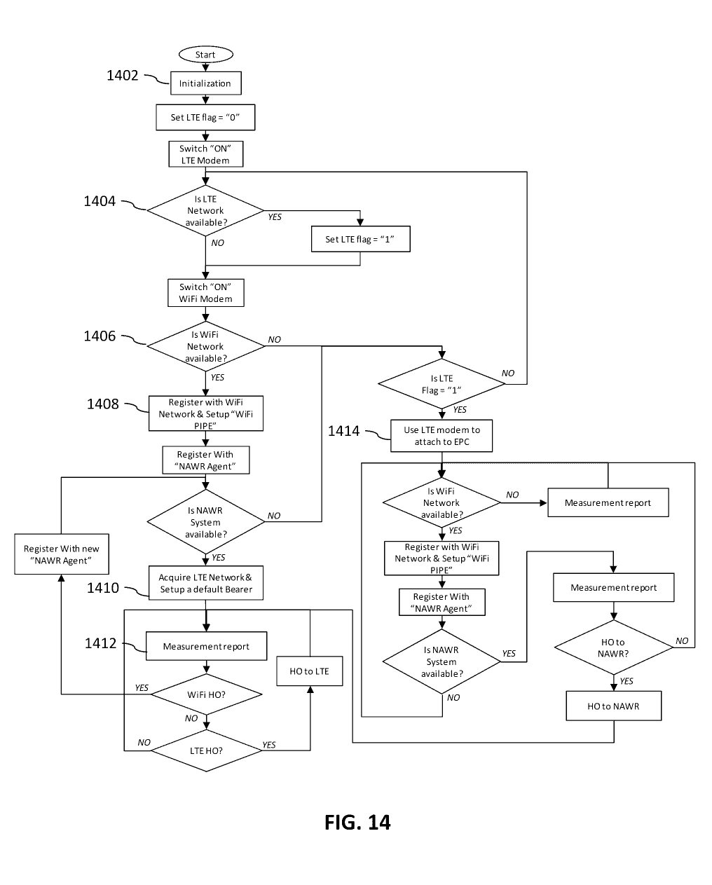

FIG. 14 illustrates an exemplary logical flow for initiating a NAWR connection of one exemplary embodiment of a NAWR APP executed on a subscriber device (UE-S) platform.

At step 1402, when the subscriber device is first Powered ON or Reset, the NAWR APP initializes and sets its internal variables and flags to default values (e.g. “LTE Flag” is reset to “0” to indicate that no LTE network is currently available).

At step 1404, after initialization, the NAWR APP enables the LTE Modem and searches for available LTE eNBs and networks. Upon detecting a desired network and eNB, the NAWR APP sets the “LTE Flag” to “1” to indicate that LTE network access is available.

Before attaching to the LTE network, the NAWR APP attempts to search for a Wi-Fi network. Generally, Wi-Fi is preferable to LTE access as Wi-Fi operation consumes less power and/or supports higher data rates, etc. It is appreciated that certain other implementations may incorporate different priority schemes.

At step 1406, the NAWR APP enables a Wi-Fi modem and looks for nearby Wi-Fi APs. In some cases, the NAWR APP may have a preferred access mode that is configured specifically to find network-agnostic wireless routers or “4G Routers”.

At step 1408, if a Wi-Fi Access Point (AP) is found, the NAWR APP will register with it. In simple implementations, the Wi-Fi AP is operating in an “open” mode. If the NAWR APP cannot register with the Wi-Fi AP then the NAWR APP proceeds as if no Wi-Fi AP was found. Closed Wi-Fi APs may still be accessible via an alternative access scheme (described subsequently).

At step 1410, if the NAWR APP has successfully registered with the Wi-Fi AP, then the NAWR APP will interrogate the AP to find out whether or not it has a suitable NAWR Agent. In one embodiment, the interrogation includes a NAWR Connection Request/NAWR Connection Grant transaction. If the NAWR interrogation is successful then the “NAWR APP” can continue with LTE network acquisition via through the Wi-Fi PIPE, using the NAWR's LTE front end.

Periodically during the NAWR connection, the NAWR APP will measure performance to determine whether a better Wi-Fi AP or LTE eNB is available. These measurements are reported to the LTE network; the LTE network may responsively cause a hand-off (HO). Exemplary measurements which are useful for HO may include, without limitation: Received Signal Strength Indicator (RS SI) signal level measurements, Signal to Noise Ratio (SNR), Bit Error Rate (BER), etc. Other useful information may include e.g., the neighbor list for LTE eNBs which is based on measurements made by the UE-S PHY which now resides in UE-R.

Referring back to step 1414, when no Wi-Fi network is available but one or more LTE networks are, the NAWR APP will proceed to use LTE network, while continuously looking for a NAWR enabled Wi-Fi AP.

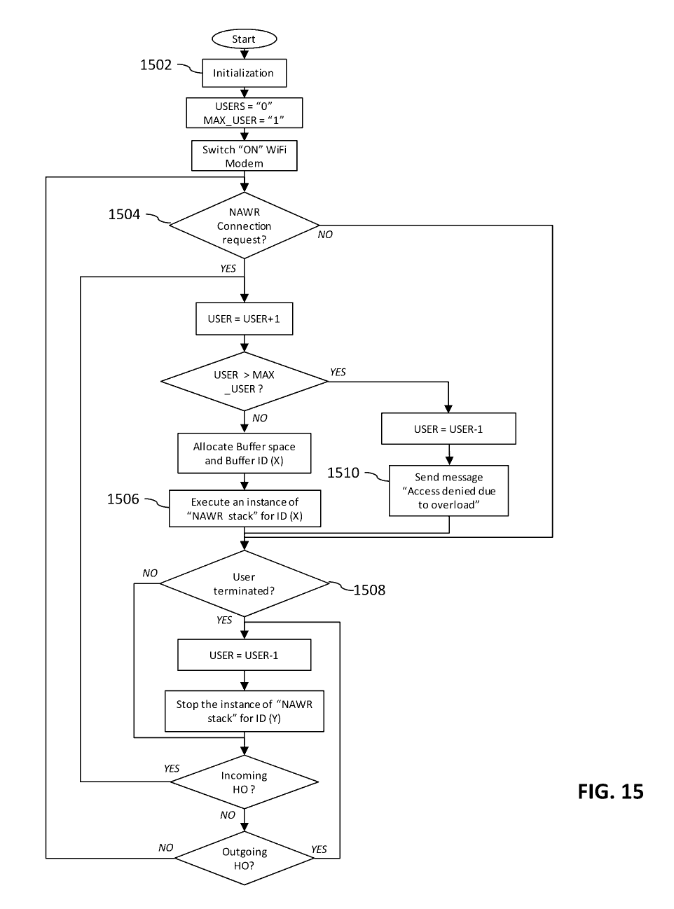

FIG. 15 illustrates a logical flow for initiating a NAWR connection of one exemplary embodiment of a NAWR Agent executed on a network-agnostic wireless router.

At step 1502, when the network-agnostic wireless router is first Powered ON or Reset, the NAWR APP initializes and sets its internal variables and flags to default values (e.g. “USER” set to “0” to indicate that no users are currently being served, and MAX_USER set to “1” for single user operation), and proceeds to switch ON the Wi-Fi Modem.

At step 1504, responsive to receiving a NAWR Connection Request message, the NAWR Agent determines whether or not the Connection Request can be serviced. In one exemplary embodiment, the NAWR Agent increments the USER register and verifies that the number of users has not exceeded the maximum allowed number of users. If the maximum allowed number of users is not reached, then the NAWR Agent proceeds to allocate buffer space on a MU Buffer & MUX/DeMUX buffer and allocate a Buffer ID to the NAWR APP, which is communicated to the NAWR APP with a NAWR Connection Grant. During subsequent transactions, the NAWR APP is expected to use the Buffer ID every time it sends a message; in some implementations, the Buffer ID may be extracted by association with a Wi-Fi user ID (e.g. MAC address) of the incoming packets).

Otherwise, if the Connection Request cannot be serviced (e.g., the maximum number of users is reached), then the new user is denied access. In some cases, an informational message is sent to inform them of the failure (e.g., system overload).

At step 1506, the NAWR Agent launches an instance of the NAWR protocol stack for the new user (Each NAWR APP requires an instance of a NAWR protocol stack).

Periodically, the NAWR Agent checks to see whether or not a user has terminated a connection (step 1508). When a user has terminated a connection, the NAWR Agent decrements the USER register and stops the corresponding NAWR protocol stack instance associated with the corresponding NAWR APP.

Incoming hand-offs (HO) have a similar flow to adding a new user (see step 1504), whereas outgoing hand-offs are similar to user termination (see step 1508).

Myriad other schemes for implementing network-agnostic wireless routing will be recognized by those of ordinary skill given the present disclosure.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

1.-21. (canceled)

22. A method for wireless communications comprising a first and a second communications systems, where the first communications system has at least a first node and a second node in communications with each other, comprising:
modifying a protocol stack of the first node, said modification comprising splitting the protocol stack into a first portion of layers and a second portion of layers, the first portion of layers and the second portion of layers configured to transact one or more data payloads;
executing the first portion of layers within the first node, and causing a third intermediary node to execute [[the]] a second portion of layers;
communicating the one or more data payloads via the second communications system, where the second communications system does not modify the one or more data payloads; and
where the combined execution of the first portion of layers and the second portion of the layers enables communications with the second node in the first communications system via the third intermediary node.

23.-24. (canceled)

25. The method of claim 23, where the splitting occurs between a radio link control (RLC) layer and medium access control (MAC) layer of a Long Term Evolution (LTE1 protocol stack.

26. The method of claim 22, further comprising providing an access tunnel via the second communications system between the first portion of layers and the second portion of layers in an unsecure open mode.

27. The method of claim 22, further comprising providing an access tunnel via the second communications system between the first portion of layers and the second portion of layers in a secure closed mode.

28. The method of claim 27, further comprising receiving (i) a key configured to encrypt data transactions with the third intermediary node,. or (ii) a credential configured to authenticate the third intermediary node of the second communications system; and
wherein the key or credential is received from the second node in the first communications system.

29. The method of claim 28, further comprising providing the key or credential to the third intermediary node, where the third intermediary node is a Network Agnostic Wireless Router (NAWR).

30. The method of claim 29, further comprising executing a NAWR software application.

31. The method of claim 30, further comprising communicating with a NAWR agent application executing on the third intermediary node.

32. The method of claim 31, further comprising establishing a NAWR dedicated control channel between the NAWR software application and the NAWR agent.

33.-36. (canceled)

37. A user equipment (UE) apparatus configured to communicate with a base station (BS) via an intermediary access point (AP), comprising:
a first wireless interface for communication with the BS;
a second wireless interface for communication with the intermediary AP;
a processor; and
a non-transitory computer readable medium comprising one or more instructions, which when executed by the processor, causes the UE apparatus to:
modify a protocol stack comprising a first portion of layers and a second portion of layers configured to transact one or more data payloads;
wherein the modification comprises execution of a first portion of layers of the protocol stack without execution of a second portion of layers of the protocol stack;
establish an access tunnel to the intermediary AP via the second wireless interface;
cause the intermediary AP to execute the second portion of layers;
communicate the one or more data payloads via the access tunnel, where the access tunnel does not modify the one or more data payloads; and
where the combined execution of the first portion of layers and the second portion of the layers enables communications with the BS via the intermediary AP.

38. The UE apparatus of claim 37, where the first wireless interface comprises a Long Term Evolution (LTE) compliant interface and the second wireless interface comprises a Wireless Local Area Network (WLAN).

39. The UE apparatus of claim 37, wherein the non-transitory computer readable medium further comprises one or more instructions that when executed by the processor, causes the UE apparatus to execute a Network Agnostic Wireless Router (NAWR) software application that is configured to interface with a NAWR agent of the intermediary AP.

40. The UE apparatus of claim 39, wherein the NAWR software application comprises a multiplexing and de-multiplexing (MUX/DeMUX) buffer.

41. The UE apparatus of claim 37, wherein the non-transitory computer readable medium further comprises one or more instructions that when executed by the processor, causes the UE apparatus to receive (i) a key configured to encrypt data transactions with the intermediary AP via the second wireless interface, or (ii) a credential configured to authenticate the intermediary AP; and
wherein the key or credential is received from the BS.

42. An intermediary access point (AP) apparatus configured to enable network agnostic access between a user equipment (UE) apparatus and one or more base stations (BSs), comprising:
a second wireless interface for communication with UE apparatus;
a first wireless interface for communication with the one or more BS;
a processor; and
a non-transitory computer readable medium comprising one or more instructions, which when executed by the processor, causes the intermediary AP apparatus to:
establish an access tunnel to the UE apparatus via the second wireless interface;
execute only a second portion of layers of a protocol stack comprising a first portion of layers and the second portion of layers configured to transact one or more data payloads with the one or more BS via the first wireless interface; and
wherein the one or more data payloads are received via the access tunnel, where the access tunnel does not modify the one or more data payloads.

43. The intermediary AP apparatus of claim 42, wherein the non-transitory computer readable medium further comprises one or more instructions that when executed by the processor, causes intermediary AP apparatus to execute a Network Agnostic Wireless Router (NAWR) agent that is configured to interface with a NAWR software application of the UE apparatus.

44. The intermediary AP apparatus of claim 43, wherein the NAWR agent comprises a multiplexing and de-multiplexing (MUX/DeMUX) buffer.

45. The intermediary AP apparatus of claim 43, where the NAWR agent is further configured to communicate with multiple UE apparatus.

46. The intermediary AP apparatus of claim 43, where the NAWR agent is further configured to communicate with the one or more BSs simultaneously, at least a portion of the one or more BSs having different Public Land Mobile Networks (PLMNs).
